(19) United States
(12) Patent Application Publication
(10) Pub. No.: US 2013/0276123 A1
(43) Pub. Date: Oct. 17, 2013

(54) MECHANISM FOR PROVIDING A SECURE ENVIRONMENT FOR ACCELERATION OF SOFTWARE APPLICATIONS AT COMPUTING DEVICES

(71) Applicants: Paul J. Thadikaran, Rancho Cordova, CA (US); Nicholas D. Triantafillou, Portland, OR (US); Paritosh Axena, Portland, OR (US)

(72) Inventors: Paul J. Thadikaran, Rancho Cordova, CA (US); Nicholas D. Triantafillou, Portland, OR (US); Paritosh Axena, Portland, OR (US)

(21) Appl. No.: 13/977,666

(22) PCT Filed: Sep. 30, 2011
(86) PCT No.: PCT/US11/54420

§ 371 Date: Jun. 28, 2013

(51) Int. Cl. G06F 21/56

(52) U.S. Cl. CPC G06F 21/56
USPC 726/24

(57) ABSTRACT

A mechanism is described for facilitating a secure environment and acceleration of software applications according to one embodiment of the invention. A method of embodiments of the invention includes initiating a software application session at a computing device. The software application session includes an anti-virus/anti-malware software-based scanning session, and the scanning session includes scanning of a plurality of locations of a storage subsystem of the computing device. The method may further include accelerating the initiated session by performing session tasks relating to the initiated session without having to rely on an operating system of the computing device.

### FIELD

The field relates generally to computing devices and, more particularly, to employing a mechanism for providing a secure environment for acceleration of software applications at computing devices.

### BACKGROUND

With the rise in the use of computing devices (e.g., mobile computing devices, such as smartphones, tablet computers, etc.), virus/malware threats are beginning to be a major concern. These viruses attack a computing device in a variety of manners, causing losses ranging from financial to productivity to intellectual property losses and can continue having a long lasting impact on the end user.

Malwares are particularly hurtful to open development environments (e.g., Android®) as they can attack the operating system components through the storage subsystem where the core operating system modules persist. Currently, anti-virus/anti-malware software (AVS) solutions run in-band, which means they are visible to the operating system of the computing device and often depend on data services provided by the infected operating system. In this cat and mouse game, the malware may enjoy the same privileges as the AVS and can therefore, distort the reality as observed by the AVS and the malware can consistently thwart any attempts to be detected by the AVS.

In addition to the above problem, for example, as smartphones are increasingly used as an additional factor for multifactor authentication (MFA), it is becoming increasingly important for the for the smartphones to have the ability to securely store data and execute services without the dependency on the data services from the operating system.

### BRIEF DESCRIPTION OF THE DRAWINGS

Embodiments of the present invention are illustrated by way of example and not by way of limitation in the figures of the accompanying drawings, in which like references indicate similar elements and in which:

FIG. 1 illustrates a computing device employing a secure environment and acceleration management mechanism for providing a secure environment for acceleration of software applications at computing devices according to one embodiment of the invention;

FIG. 2 illustrates a secure environment and acceleration management mechanism employed at a computing device according to one embodiment of the invention;

FIG. 3A illustrate a placement of a hardware accelerator at a storage media according to one embodiment of the invention;

FIG. 3B illustrates an overall placement of a secure environment and acceleration management mechanism at a computing device according to one embodiment of the invention;

FIG. 3C illustrates a scanning mechanism of a secure environment and acceleration management mechanism at a computing device according to one embodiment of the invention;

FIG. 4A illustrates a transaction sequence for facilitating session and authentication processes using a secure environment and acceleration of software applications provided by a secure environment and acceleration management mechanism according to one embodiment of the invention;

FIG. 4B illustrates a method for facilitating a secure environment and acceleration of software applications provided by a secure environment and acceleration management mechanism according to one embodiment of the invention; and

FIG. 5 illustrates a computing system according to one embodiment of the invention.

### DETAILED DESCRIPTION

Embodiments of the invention provide a mechanism for facilitating a secure environment and acceleration of software applications according to one embodiment of the invention. A method of embodiments of the invention includes initiating a software application session at a computing device. The software application session includes an anti-virus/anti-malware software-based scanning session, and the scanning session includes scanning of a plurality of locations of a storage subsystem of the computing device. The method may further include accelerating the initiated session by performing session tasks relating to the initiated session without having to rely on an operating system of the computing device.

Furthermore, a system or apparatus of embodiments of the invention may provide the mechanism for facilitating a secure environment and acceleration of software applications and perform the aforementioned processes and other methods and/or processes described throughout the document. For example, in one embodiment, an apparatus of the embodiments of the invention may include a first logic to perform the aforementioned initiating of a session, a second logic to perform the aforementioned acceleration of the initiated session, and the like, such as other or the same set of logic to perform other processes and/or methods described in this document.

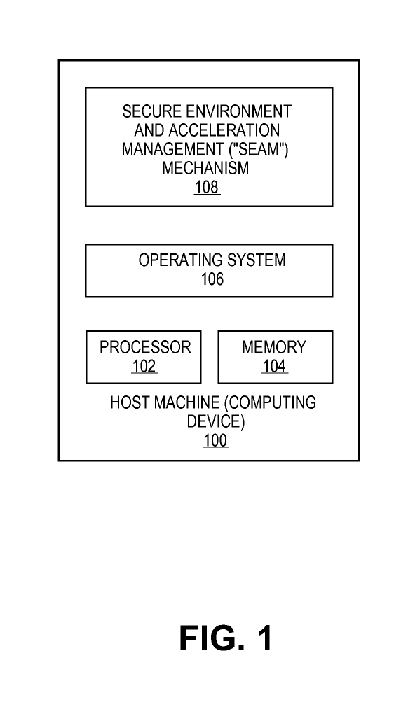

FIG. 1 illustrates a computing device employing a secure environment and acceleration management mechanism for providing a secure environment for acceleration of software applications at computing devices according to one embodiment of the invention. In one embodiment, a computing device 100 is illustrated as having a secure environment acceleration management (“SEAM”) mechanism 108 to provide a secure environment for acceleration of software applications at computing devices. Computing device 100 may include mobile computing devices, such as cellular phones including smartphones (e.g., iPhone®, BlackBerry®, etc.), handheld computing devices, personal digital assistants (PDAs), etc., tablet computers (e.g., iPad®, Samsung® Galaxy Tab®, etc.), laptop computers (e.g., notebooks, netbooks, etc.), e-readers (e.g., Kindle®, Nook®, etc.), etc. Computing device 100 may further include larger computing devices, such as desktop computers, server computers, etc.

In one embodiment, the SEAM mechanism 108 provides (1) an out-of-band scheme to provide trusted and secure operations, such as e-commerce, access to digital rights protected and otherwise controlled information, and multi-factor authentication use cases, etc.; (2) through the use of an Application Programming Interface (“API”) (or Software Development Kit (“SDK”), etc.) that allows software applications developed by Independent Software Vendors (“ISVs”) for smartphones to readily scale to other system form factors, such as e-Readers, tablet computers, PDAs, Internet-capable set-top boxes, etc., independent of the nature, attributes and characteristics of the hardware and software/firmware accelerators used to provide secure execution and multi-factor authentication capabilities.

Computing device 100 includes an operating system 106 serving as an interface between any hardware or physical resources of the computer device 100 and a user. Computing device 100 further includes one or more processors 102, memory devices 104, network devices, drivers, or the like, as well as input/output sources, such as touchscreens, touch panels, touch pads, virtual or regular keyboards, virtual or regular mice, etc. It is to be noted that terms like “machine”, “device”, “computing device”, “computer”, “computing system”, and the like, are used interchangeably and synonymously throughout this document.

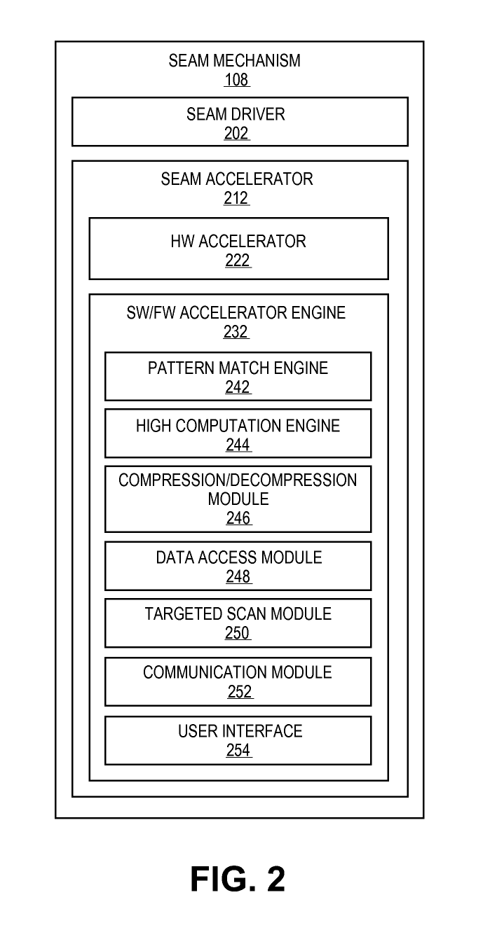

FIG. 2 illustrates a secure environment and acceleration management mechanism employed at a computing device according to one embodiment of the invention. In one embodiment, the SEAM mechanism 108 includes a SEAM driver 202 and a SEAM accelerator 212 to provide a secure execution environment for software applications (e.g., AVS applications/solutions). In one embodiment, the SEAM accelerator 212 is provided in hardware as hardware (“HW)” accelerator 222 that is provided as a hardware block embedded or interconnected as part of the computer device's storage media (e.g., storage subsystem, raw secondary storage, such as consumer electronic ATA (“CE-ATA”), Open NAND Flash Interface (“ONFI”), Secure Device (SD)/MultiMediaCard (MMC), etc.) of, for example, a mobile computing device's system-on-chip (“SoC”). The SEAM mechanism 108 provides an out-of-band scheme that enables a secure access of data that is resident in the storage media. This feature can be securely accessed by an authorized anti-virus/anti-malware vendors. In one embodiment, the SEAM mechanism 108 provides a SEAM driver 202 to facilitate interfacing of authorized an AVS solution with the HW accelerator 222 employed at the SoC. The HW accelerator implements in Silicon the performance intensive modules for data manipulation as needed in the various applications using the SEAM mechanism 108.

In one embodiment, the SEAM mechanism 108 further provides the SW/FW accelerator engine 232 that includes a pattern match engine 242, a hash computation engine 244, a compression/decompression module 246, a data access module 248, a communication module 252, and a user interface 254. The pattern match engine 242 may be implemented or performed using one or more software algorithms, such as Boyer-Moore, Aho-Corasik, etc. The hash computation engine 244 may be used to compute hashing standards, such as SHA-2, MD5, etc. Similarly, the compression/decompression module 246 may be implemented or performed using one or more software algorithms, such as LZ77, LZS, etc. The data access module 248 refers to firmware-based trusted data services to access sector/block level data from the storage media without dependency on the operating system.

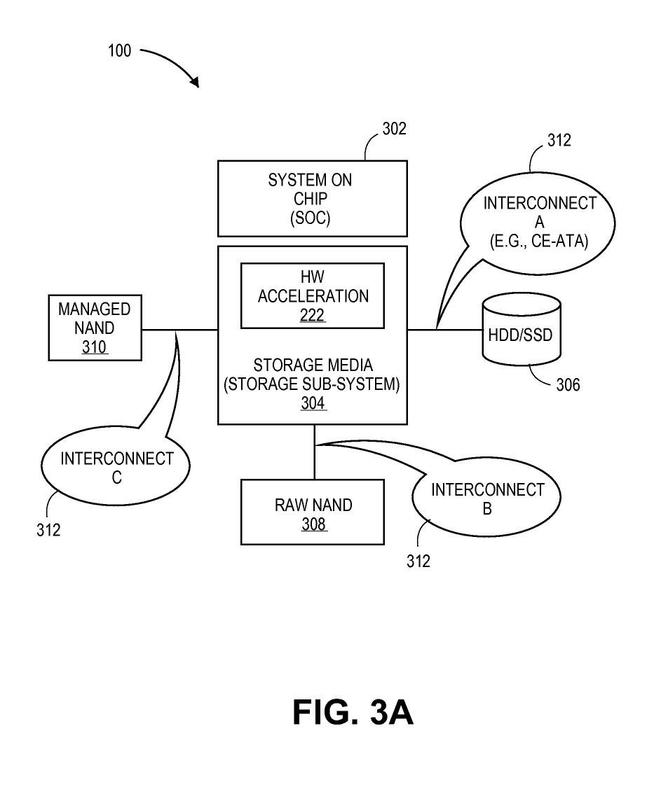

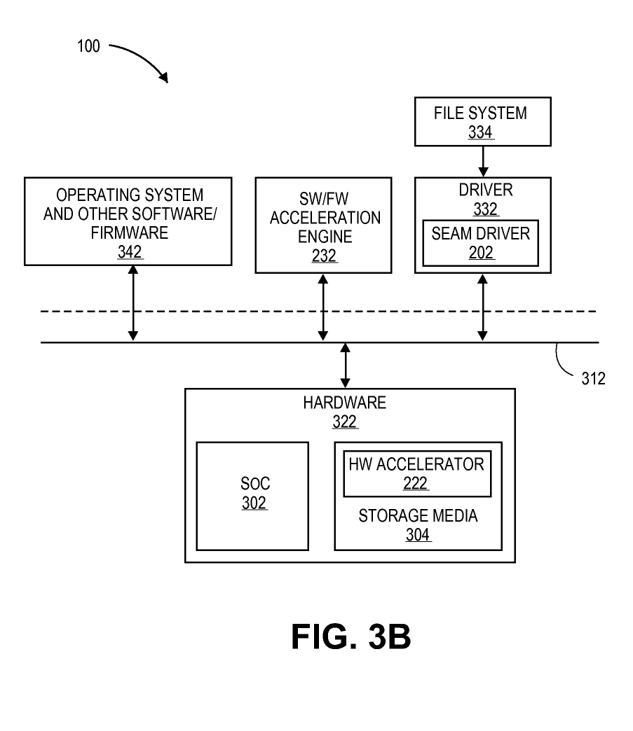

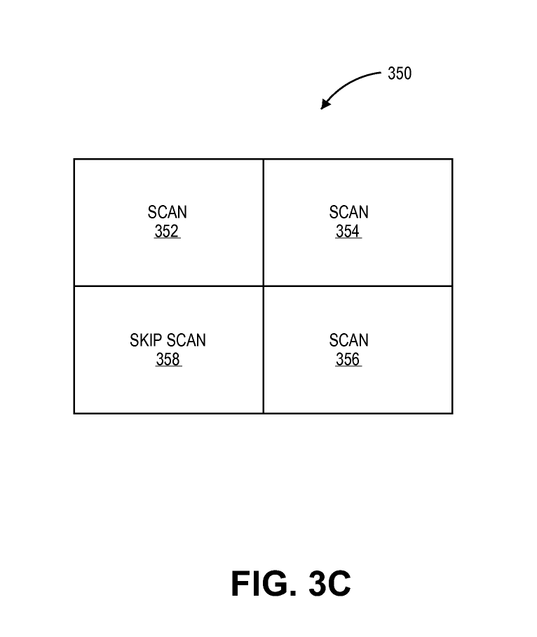

In one embodiment, the hash computation engine 244 may provide a time-based hash (“TBH”) function that is used to generate “differential information” (e.g., to create a record of which files changed and when, generate information on what changed between different versions of files, such as ISV' s DAT files, etc.). The TBH function is further to minimize the number of files that needed be scanned. Further, using trusted differential information generated by the TBH function and .DAT files provided by ISVs, AVS solutions can executed targeted scans using rules and heuristics that can at the simplest level be represented in the chart provided with referenced to FIG. 3C. Differential information is generated and logged by the storage media along with a log (e.g., information inventory) of events, identity of virus and malware detected, status of resolutions (e.g., successes, failures, etc.), etc. Such information may be out of reach and control of the operating system. Anti-virus/anti-malware-capable mobile computing devices may be treated by the ISVs and information technology (“IT”) departments as virus and malware sensors so that the real-time information can be compiled and accessed to assess the nature and level of security threats as well as to assess the impact-particular actions (e.g., Region of Interest (“ROI”)) taken with a network employing computing devices.

Further, the pattern match engine 242 may be used as a general purpose filter and data-mining engine. The use of the pattern match engine 242 speeds up searches of both the unstructured and structured information and such searches can be power-efficient with the ability to meet the “instant response” expectations in a mobile computing device (e.g., smartphone). The pattern matching acceleration provided by the SW/FW accelerator engine 232 may be non-general-purpose-computing (non-CPU, non-GP-GPU, etc.) and provides a trusted differential information with time-based hash.

The compression/decompression module 246 of the SEAM mechanism 108 perform compression and/or decompression of data using one or more novel and/or existing software algorithms, such as LZ77, LZS, etc. The data access module 248 refers to a firmware-based trusted data services system to access sector/block level data from the storage media without depending on the operating system. In other words, the data access module 248 removes the need of an AVS solution to depend on the potentially corrupt data services that rely on the operating system, particularly in an open environment system (e.g., Android) where the operating system is open to accessible and thus open to attacks. Using the data access module 248, secure access of storage data is performed through alternate channels (e.g., without going through data services provided by the operating system) to reduce the vulnerability of malware modification of data.

The SEAM mechanism 108 further includes a communication module 252 to facilitate communication between various components of the SEAM mechanism 108 as well as enable the SEAM mechanism 108 to communicate with other hardware components and software applications or algorithms of the computing system. For example, the communication module 252 may work with the SEAM driver 202 to facilitate communication between the SEAM accelerator 212 and the hardware components of the computing system. Further, any messages are sent securely over shared bus(es) (e.g., CE-ATA, etc.) using customized or vendor-specified commands. Further, a user interface 254 is provided for the end user to communicate with the SEAM mechanism 108 (e.g., to start/pause/stop the SEAM mechanism 108 from running, to review any relevant data in various formats, such as text, graphs, charts, etc.).

In one embodiment, differential information (e.g., regarding whether changes have been made to end-user files and applications as well as whether specific changes have been made to ISV (.DAT) AV-AM pattern files, etc.). Using the SEAM accelerator 212, pattern matching, hash computation, compression and/or decompression, and data services access are performed, where the SEAM accelerator's hardware accelerator 222 is embedded into the computing device's storage subsystem or elsewhere in the platform where needed (e.g., the hardware block accelerator 222 may be placed at a SoC of a mobile computing device, such as a smartphone or a tablet computer, etc.). Further, auto-backup of data files stored on the storage device is performed to allow seamless auto-recovery of information, particularly in case of the storage device being infected by viruses or malware. These novel techniques improve the overall AVS efficiency and reduce any impact on the user experience (e.g., the end-user may not even notice that they are using an AVS solution). With regard to software developers and ISVs, these techniques solve their problems by allowing them to re-use their investment and readily scaling the results of their work and capabilities of ISV infrastructure across diverse collections of form factors and of diverse underlying hardware (including the CPU) architectures. The SEAM mechanism 108 provides for a secure environment by which software applications are developed through secure elements, secure/trusted execution, trusted storage, sensors, and multi-factor authentication capabilities can more readily scale to work on various computing devices across different from factors and diverse underlying computing architectures.

In one embodiment, targeted scan module 350 is provided by the SEAM mechanism to facilitate smart scanning of user workloads for execution and acceleration of software programs (e.g., anti-virus/anti-malware solutions, etc.). The availability of trusted differential information may hold the potential to reduce scanning workloads by orders of magnitude depending on the user's usage models and/or history and the time allowed between AVS scans. In one embodiment, using the targeted scan module 350, this novel scanning scheme works such that if any change is made to the smallest or lowest unit (e.g., a sector or block) of data represented in the storage medium (e.g. storage subsystem, etc.), then that smallest unit is marked for scanning by the targeted scan module 350. For example, if an attacker modifies a sector/block, then it is automatically scanned during the next scheduled run of an AVS. In one embodiment, as is illustrated in FIG. 3C, the targeted scan module 350 monitors the user activity as it relates to the data represented in the storage medium and if a change in a sector/block is detected that is regarded as new and/or different from those regarded as acceptable based on user's usage model and/or history, then that change is scanned during the next scan run of the AVS. However, if no change is detected and/or the change is according to the user's usage module and/or history, that sector is skipped during the scan run. This skipping of the potential scan provides for an efficient scanning of data and reduces the length of scanning and/or eliminates any unnecessary scans or scan runs.

In one embodiment, secure functions are provided to be consumed in a scalable manner by various software applications and software application developers in a novel manner that is independent of the underlying physical hardware and other hardware elements used to build different form-factors. Further, algorithms implemented as ASIC blocks in the storage subsystems (including SSD and HDD SoCs, etc.) and elsewhere on platforms or as firmware running securely on microcontrollers (e.g., hash functions (including but not limited to SHA-256, true random number generators, etc.) are to be exposed via API call functions to software applications and software application developers allowing the applications to readily scale across a diverse set of computing devices (regardless of the host CPU micro-architecture, operating system, device form-factors, and with minimum dependency on the nature of sensors and multi-factor authentication capabilities).

In one embodiment, the employment and implementation of the SEAM mechanism 108 may use the user interface 254 to provide a two-tiered API structure that can expose, in a scalable manner, the hardware and firmware derived (e.g., data services) capabilities to various software applications running on the host processor as well as to any remote agents (such as ISV backend infrastructure). The first tier may include an API-L that is intended for and workable with software applications (running on host CPUs and remote agents) or to lower level firmware modules executed using secure execution capabilities identified/detected (by API-L libraries, IPPs, and tools, etc.) to be active within computing devices, access to numerous secure firmware functions and access to trusted data and metadata generated by sensors and multi-factor authentication devices/capabilities.

The second tier may include an API-H that is intended to provide to software applications (running on host CPUs and remote agents) access to secure firmware modules capable of supporting higher level (e.g., higher-level firmware, middle-level firmware, etc.) capable of supporting various use cases (including, but not limited to secure scan, e-commerce, client manageability, asset management, anti-theft, secure storage, e-wallet, media vault, document control, timed access to secure documents, timed access to digital rights-protected content, etc.) implemented using a programming models based on the API-L.

It is contemplated that any number and type of components may be added to and removed from the SEAM mechanism 108 to facilitate the workings and operability of the SEAM mechanism 108 for providing a secure environment for acceleration of software applications at computing devices between computing devices. For brevity, clarity, ease of understanding and to focus on the SEAM mechanism 108, many of the default or known components of a computing device are not shown or discussed here.

FIG. 3A illustrates a placement of a hardware accelerator at a storage media according to one embodiment of the invention. In the illustrated embodiment, a computer system 100 (e.g., a mobile computing device, such as a smartphone) having a SoC 302 and a storage media 222, such as a storage subsystem. In one embodiment, the hardware accelerator 222 may be embedded or implanted on to the storage subsystem 304 as a hardware block. The storage medium 304 may be in communication with a managed NAND 310, a raw NAND 308, another storage medium 306 (e.g., HDD/SSD), and a number of interconnects A-C 312 (e.g., CE-ATA, ONFI, SD/(e)MMC, etc.).

FIG. 3B illustrates an overall placement of a secure environment and acceleration management mechanism at a computing device 100 according to one embodiment of the invention. The computing device 100 illustrated here may be the same as or similar to the computing device 100 of FIG. 1 (e.g., a mobile computing device, such as a smartphone) and include an interconnect 312 (as shown in FIG. 3A) to connect and communicate the computing device's software with its hardware. For example, the hardware 322 includes a processor or chip 302 (e.g., SoC as in a mobile computing device) and storage media 304 employing, in one embodiment, the hardware accelerator 222. Over on the software side, the computing device 100 includes an operating system and other software and firmware 342 that are needed to successfully run any computing device 100. Further, a software/firmware accelerator engine 232 resides on the software side of the computing device 100, while the computing device 100 further includes a file system 334 in communication with a device driver 332 employing, in one embodiment, a SEAM driver 202. The SEAM driver 202, in one embodiment, is used to provide a bilateral communication between the hardware 322 (including the hardware accelerator 222) and the software (including the SW/HW accelerator engine 232). The dotted line represents the divide between the computing device's software (above) and hardware 322 (below).

FIG. 3C illustrates a scanning mechanism of a secure environment and acceleration management mechanism at a computing device according to one embodiment of the invention. As aforementioned with reference to FIG. 2, the targeted scan module of the SEAM mechanism is used to facilitate smart scanning of user workloads for execution and acceleration of software programs (e.g., anti-virus/anti-malware solutions, etc.). The availability of trusted differential information may hold the potential to reduce scanning workloads by orders of magnitude depending on the user's usage models and/or history and the time allowed between AVS scans. In one embodiment, using the targeted scan module, this novel scanning scheme works such that if any change is made to the smallest or lowest unit (e.g., a sector or block) of data represented in the storage medium (e.g. storage subsystem, etc.), then that smallest unit is marked for scanning by the targeted scan module. For example, if an attacker modifies a sector/block, then it is automatically scanned during the next scheduled run of an AVS.

As illustrated, the targeted scan module 250 monitors the user activity as it relates to the data represented in the storage medium and if a change in a sector/block is detected (such as by the attacker, hacker, etc.) that is regarded as new and/or different from those regarded as acceptable based on user's usage model and/or history, then that change is scanned during the next scan run of the AVS. In this case, for example, the sectors/blocks 352, 354, 356 are scanned as usual, but because no change is detected and/or the change is according to the user's usage module and/or history at sector/block 358, that sector 358 is skipped during the scan run. This skipping of the potential scan provides for an efficient scanning of data and reduces the length of scanning and/or eliminates any unnecessary scans or scan runs.

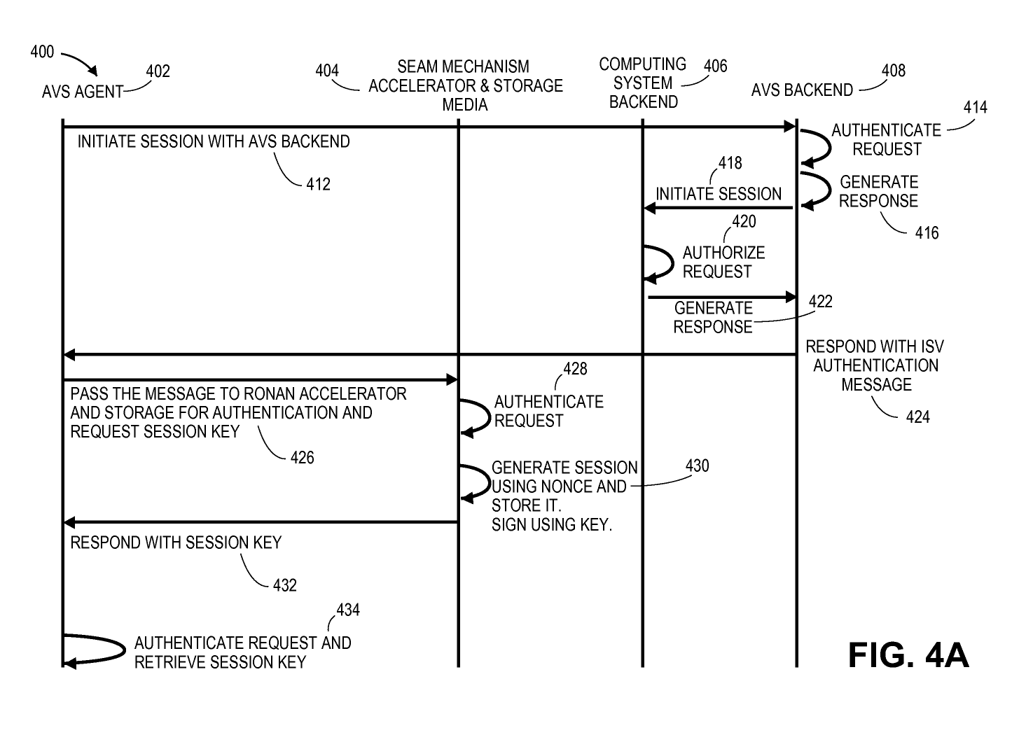

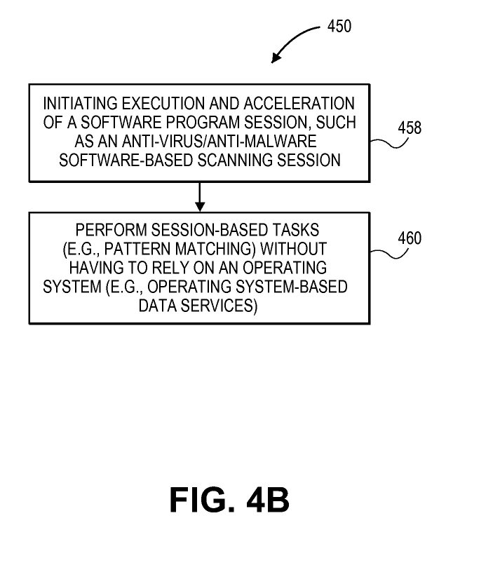

FIG. 4A illustrates a transaction sequence for facilitating session and authentication processes using a secure environment and acceleration of software applications provided by a secure environment and acceleration management mechanism according to one embodiment of the invention. Method 400 may be performed by processing logic that may comprise hardware (e.g., circuitry, dedicated logic, programmable logic, etc.), software (such as instructions run on a processing device), or a combination thereof. In one embodiment, transaction sequence 400 may be performed by the SEAM mechanism of FIG. 1.

Transaction sequence 400 starts with an AVS agent 402 of an anti-virus/anti-malware software program initiating a session 412 with an AVS backend 408. The session may refer to a session to check a computing device for virus or malware and include checking the workloads or data stored at a storage medium of the computing device by scanning each sector or block of the storage medium. The AVS backend 408 authenticates the request 414 and generates response 416 that is communicated to the computing device's processor backend 406. The requested session is initiated 418 and the request is authorized 420 in communication with the SEAM mechanism's hardware and software/firmware accelerators and the storage media 404 holding the workload/data, and a response is generated 422 and is then communicated to the AVS background 418. It is to be noted that in one embodiment, the hardware accelerator of the SEAM mechanism may be installed on or embedded onto the storage media 404.

In one embodiment, the AVS backend 418 then responds to the AVS agent 402 with an ISV authentication message 424. The message from the AVS agent 402 is then passed on to the hardware and software/firmware accelerators and storage media 404 for authentication and to request a session key 426. At the accelerators and storage media 404, the request is authenticated 428 and a session is generated and stored 430 and the session is signed in using the newly generated key 430. A response including the session key 432 is sent to the AVS agent 402. At the AVS agent 402, the request is authenticate and the session key is retrieved 434 to begin the session.

FIG. 4B illustrates a method for facilitating a secure environment and acceleration of software applications provided by a secure environment and acceleration management mechanism according to one embodiment of the invention. Method 450 may be performed by processing logic that may comprise hardware (e.g., circuitry, dedicated logic, programmable logic, etc.), software (such as instructions run on a processing device), or a combination thereof. In one embodiment, method 450 may be performed by the SEAM mechanism of FIG. 1.

Method 450 begins with block 458 with initiating of an execution of a software program session (e.g., a scanning session by an anti-virus/anti-malware software program). At block 460, the software program session is initiated and the session's tasks (e.g., checking of data for virus and malware is performed by scanning various sectors of a storage medium, including performing pattern matching) as performed using the SEAM mechanism (including its SEAM driver and hardware/software-firmware accelerators) without having to rely on operating system-based data services (e.g., data services that are depending on an open environment-based operating system). In one embodiment, the scanning further includes skipping of scanning of certain sectors when no change is detected at those sectors. In other words, the no-change sectors are skipped over, while scanning of other sections where a change is detected are scanned which leads to an efficient and accelerated method of scanning saving valuable resources of time and space for the computing system.

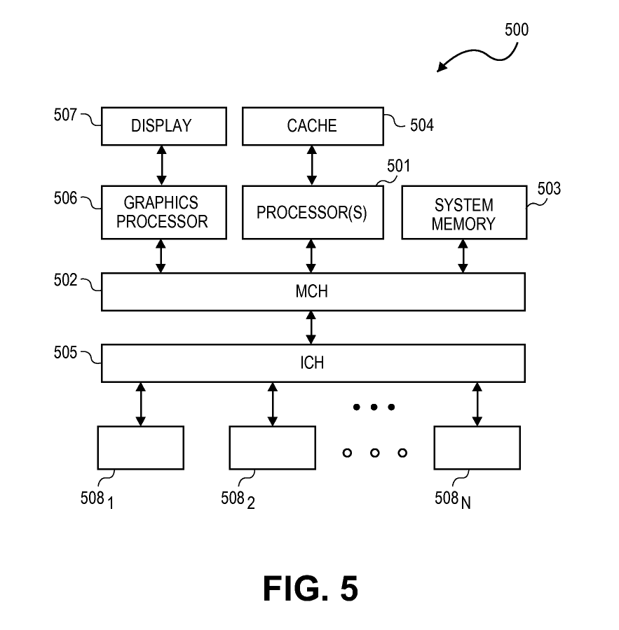

FIG. 5 illustrates a computing system employing and facilitating a secure environment and acceleration of software applications provided by a secure environment and acceleration management mechanism according to one embodiment of the invention. The exemplary computing system 500 may be the same as or similar to the computing system 100 of FIG. 1 (e.g., a mobile computing device, such as a tablet computer) and include: 1) one or more processors 501 at least one of which may include features described above; 2) a memory control hub (MCH) 502; 3) a system memory 503 (of which different types exist such as double data rate RAM (DDR RAM), extended data output RAM (EDO RAM) etc.); 4) a cache 504; 5) an input/output (I/O) control hub (ICH) 505; 6) a graphics processor 506; 7) a display/screen 507 (of which different types exist such as Cathode Ray Tube (CRT), Thin Film Transistor (TFT), Light Emitting Diode (LED), Molecular Organic LED (MOLED), Active matrix molecular LED (AMOLED), Liquid Crystal Display (LCD), Digital Light Projector (DLP), etc.; and 8) one or more I/O devices 508.

The one or more processors 501 execute instructions in order to perform whatever software routines the computing system implements. The instructions frequently involve some sort of operation performed upon data. Both data and instructions are stored in system memory 503 and cache 504. Cache 504 is typically designed to have shorter latency times than system memory 503. For example, cache 504 might be integrated onto the same silicon chip(s) as the processor(s) and/or constructed with faster static RAM (SRAM) cells whilst system memory 503 might be constructed with slower dynamic RAM (DRAM) cells. By tending to store more frequently used instructions and data in the cache 504 as opposed to the system memory 503, the overall performance efficiency of the computing system improves.

System memory 503 is deliberately made available to other components within the computing system. For example, the data received from various interfaces to the computing system (e.g., keyboard and mouse, printer port, Local Area Network (LAN) port, modem port, etc.) or retrieved from an internal storage element of the computer system (e.g., hard disk drive) are often temporarily queued into system memory 503 prior to their being operated upon by the one or more processor(s) 501 in the implementation of a software program. Similarly, data that a software program determines should be sent from the computing system to an outside entity through one of the computing system interfaces, or stored into an internal storage element, is often temporarily queued in system memory 503 prior to its being transmitted or stored.

The ICH 505 is responsible for ensuring that such data is properly passed between the system memory 503 and its appropriate corresponding computing system interface (and internal storage device if the computing system is so designed). The MCH 502 is responsible for managing the various contending requests for system memory 503 accesses amongst the processor(s) 501, interfaces and internal storage elements that may proximately arise in time with respect to one another.

One or more I/O devices 508 are also implemented in a typical computing system. I/O devices generally are responsible for transferring data to and/or from the computing system (e.g., a networking adapter); or, for large scale non-volatile storage within the computing system (e.g., hard disk drive). ICH 505 has bi-directional point-to-point links between itself and the observed I/O devices 508.

Portions of various embodiments of the present invention may be provided as a computer program product, which may include a computer-readable medium having stored thereon computer program instructions, which may be used to program a computer (or other electronic devices) to perform a process according to the embodiments of the present invention. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer -readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

In the foregoing specification, the invention has been described with reference to specific exemplary embodiments thereof. It will, however, be evident that various modifications and changes may be made thereto without departing from the broader spirit and scope of the invention as set forth in the appended claims. The Specification and drawings are, accordingly, to be regarded in an illustrative rather than a restrictive sense.

1. A computer-implemented method comprising:
initiating a software application session at a computing device, wherein the software application session comprises an anti-virus/anti-malware software-based scanning session, wherein the scanning session comprises scanning of a plurality of locations of a storage subsystem of the computing device; and
accelerating the initiated session by performing session tasks relating to the initiated session without having to rely on an operating system of the computing device.

2. The computer-implemented method of claim 1, further comprising detecting a change at at least one of the plurality of locations of the storage subsystem, the change representing an attempted access of the computing device by an attacker.

3. The computer-implemented method of claim 2, further comprising skipping scanning of one or more locations of the plurality of locations, wherein the one or more locations are not detected as having a change.

4. The computer-implemented method of claim 1, wherein the operating system comprises an open-environment operating system.

5. The computer-implemented method of claim 1, wherein acceleration is performed via an accelerator, wherein the accelerator comprises a hardware accelerator embedded in the storage subsystem of the computing device.

6. The computer-implemented method of claim 1, wherein acceleration is performed via an accelerator engine, wherein the accelerator engine comprises a targeted scan module to perform targeted scanning of user workload, wherein targeted scanning comprises reducing a number of scanning sessions by referencing one or more of use model, usage history, and time allowed between consecutive scanning sessions to determine with the scanning sessions are to be performed.

7. The computer-implemented method of claim 6, wherein the accelerator engine further comprises one or more a pattern match engine, a hash computation engine, a compression/decompression module, a data access module, a communication module, and a user interface.

8. The computer-implemented method of claim 1, wherein the computing device comprises a mobile computing device comprising one or more of smartphones, personal digital assistants (PDAs), handheld computers, e-readers, tablet computers, notebooks, and netbooks.

9. A system comprising:
a computing device having a memory to store instructions, and a processing device to execute the instructions, wherein the instructions cause the processing device to:
initiate a software application session at the computing device, wherein the software application session comprises an anti-virus/anti-malware software-based scanning session, wherein the scanning session comprises scanning of a plurality of locations of a storage subsystem of the computing device; and
accelerate the initiated session by performing session tasks relating to the initiated session without having to rely on an operating system of the computing device.

10. The system of claim 9, wherein the processing device is further to detect a change at at least one of the plurality of locations of the storage subsystem, the change representing an attempted access of the computing device by an attacker.

11. The system of claim 10, wherein the processing device is further to skip scanning of one or more sectors of the plurality of locations, wherein the one or more locations are not detected as having a change.

12. The system of claim 9, wherein the operating system comprises an open-environment operating system.

13. The system of claim 9, wherein acceleration is performed via an accelerator, wherein the accelerator comprises a hardware accelerator embedded in the storage subsystem of the computing device.

14. The system of claim 9, wherein acceleration is performed via an accelerator engine, wherein the accelerator engine comprises a targeted scan module to perform targeted scanning of user workload, wherein targeted scanning comprises reducing a number of scanning sessions by referencing one or more of use model, usage history, and time allowed between consecutive scanning sessions to determine with the scanning sessions are to be performed.

15. The system of claim 14, wherein the accelerator engine further comprises one or more a pattern match engine, a hash computation engine, a compression/decompression module, a data access module, a communication module, and a user interface.

16. (canceled)

17. At least one machine-readable medium having stored thereon instructions that, when executed by a computing device, cause the computing device to:
initiate a software application session at the computing device, wherein the software application session comprises an anti-virus/anti-malware software-based scanning session, wherein the scanning session comprises scanning of a plurality of locations of a storage subsystem of the computing device; and
accelerate the initiated session by performing session tasks relating to the initiated session without having to rely on an operating system of the computing device.

18. The machine-readable medium of claim 17, wherein one or more instructions that, when executed by the computing device, further cause the computing device to detect a change at at least one of the plurality of locations of the storage subsystem, the change representing an attempted access of the computing device by an attacker.

19. The machine-readable medium of claim 18, wherein one or more instructions that, when executed by the computing device, further cause the computing device to skip scanning of one or more locations of the plurality of locations, wherein the one or more locations are not detected as having a change.

20. The machine-readable medium of claim 17, wherein the operating system comprises an open-environment operating system.

21. The machine-readable medium of claim 17, wherein acceleration is performed via an accelerator, wherein the accelerator comprises a hardware accelerator embedded in the storage subsystem of the computing device.

22. The machine-readable medium of claim 17, wherein acceleration is performed via an accelerator engine, wherein the accelerator engine comprises a targeted scan module to perform targeted scanning of user workload, wherein targeted scanning comprises reducing a number of scanning sessions by referencing one or more of use model, usage history, and time allowed between consecutive scanning sessions to determine with the scanning sessions are to be performed.

23. The machine-readable medium of claim 22, wherein the accelerator engine further comprises one or more a pattern match engine, a hash computation engine, a compression/decompression module, a data access module, a communication module, and a user interface.

24. (canceled)
